(19) United States
(12) Patent Application Publication
(10) Pub. No.: US 2026/0365075 A1
(43) Pub. Date: Nov. 19, 2026

(54) Mobile Utility for Logistics and Energy

(71) Applicants: Laurence E. Allen, III, San Rafael, CA (US); Laurence E. Allen, IV, Berkeley, CA (US); Cole Brayton Johnson, Atlanta, GA (US)

(72) Inventors: Laurence E. Allen, III, San Rafael, CA (US); Laurence E. Allen, IV, Berkeley, CA (US); Cole Brayton Johnson, Atlanta, GA (US)

(21) Appl. No.: 19/642,301

(22) Filed: Apr. 8, 2026

Related U.S. Application Data
(63) Continuation-in-part of application No. 17/176,192, filed on Feb. 16, 2021.
(63) Continuation-in-part of application No. 18/629,026, filed on Apr. 8, 2024.
(60) Provisional application No. 63/785,571, filed on Apr. 8, 2025.

(51) Int. Cl. B60L 58/12; B60L 1/00; B60L 15/00; B60L 50/60; B60L 53/51; B60L 53/62; B60L 55/00; B60L 58/14; G06Q 30/04; G07C 5/00

(52) U.S. Cl. CPC B60L 58/12; B60L 1/006; B60L 50/60; B60L 53/62; B60L 55/00; B60L 58/14; B60L 15/007; B60L 53/51; B60L 2210/40; B60L 2240/545; G06Q 30/04; G07C 5/008

(57) ABSTRACT

A mobile battery energy storage system (“M.U.L.E.”) integrates a high-capacity traction battery, power electronics for both AC/DC output, and mesh-connected control. Able to travel from renewable charging bases to remote or off-grid sites, it supplies on-demand energy for industrial, agricultural, or emergency tasks. Modular batteries can be rapidly offloaded or swapped without specialized gear, while predictive scheduling and just-in-time charging optimize performance. A cloud-based platform uses real-time demand and location-based pricing, dispatching units to maximize revenue for renewable producers. Contracts can be structured by kWh, capacity reservation, or dynamic models reflecting scarcity and distance. Standardized connectors ensure compatibility with varied machinery, reducing reliance on diesel generators. By uniting mobility with stationary power, this solution expands clean energy markets, fosters emissions-free operations, and creates a decentralized “mobile grid” adaptable to evolving demands.

### TECHNICAL FIELD OF THE INVENTION

The present invention relates to mobile and modular battery energy storage systems designed for off-grid, remote, and emergency energy delivery applications. Specifically, the invention provides a scalable platform for forecast-driven power deployment using predictive control logic, mesh networking, and real-time telemetry to enable dynamic AC or DC energy transfer, both in transit and at distributed field locations.

### BACKGROUND OF THE INVENTION

Off-grid and remote sites frequently require access to reliable, high-capacity energy delivery systems for powering industrial equipment, vehicles, water pumps, construction machinery, wood grinders or emergency services. Current solutions typically rely on diesel generators or stationary containerized battery storage. These methods suffer from a range of limitations, including the fuel cost and emissions of generators, the immobility of large battery containers, and the logistical challenges of getting power exactly where it is needed at precisely the right time.

In parallel, electric vehicles (EVs) have demonstrated the advantages of high-density rechargeable batteries and robust power electronics, yet EV technology has remained largely separate from broader, off-vehicle energy-distribution needs. Some vehicles can serve as mobile backup power sources on a modest scale (e.g., “vehicle-to-home” systems), but they generally lack the capacity or dedicated infrastructure to supply high-voltage AC, high-voltage DC, or other outputs suitable for heavy-duty or large-scale applications.

Moreover, there is an unmet need for predictive control in such mobile energy systems. Many existing systems are simply kept at or near full state-of-charge (SOC) to ensure availability, a practice that accelerates battery degradation and does not take advantage of real-time load data or external forecasts (like weather or operational schedules) to optimize charge/discharge timing. Without such intelligence, operators risk unnecessary generator runs, inefficient battery usage, and difficulty coordinating multiple power nodes across a remote job site or disaster area.

Against this backdrop, the invention described herein—referred to as M.U.L.E. or MULE (Mobile Utility for Logistics and Energy)—bridges these gaps by merging the traction battery of an electric vehicle with a sophisticated power electronics suite and a multi-channel communication architecture (local mesh plus optional satellite/cloud integration). This approach enables the vehicle to function not only as a fully operational EV but also as a high-capacity, mobile power supply capable of delivering both AC (e.g., 480 V, 575 V three-phase or other useful voltage) and high-voltage DC (e.g., 800-1000 V DC) to remote locations directly for electrical loads or to charge auxiliary battery modules used for site power storage or to which are integrated into vehicles. Through predictive algorithms, the system can optimize “just-in-time” charging and discharging, minimizing battery wear while ensuring power is delivered precisely where and when it is most needed.

Renewable energy sources, notably solar power, are commonly constrained by long-term utility contracts that limit the solar developer's revenue streams to a single buyer or a fixed set of buyers. This restrictive arrangement prevents capturing higher-value opportunities such as remote or off-grid markets, where energy is urgently needed but often relies on costly and inefficient diesel generators. At the same time, diesel-powered operations in the field must oversize their generators to meet infrequent but substantial power spikes, leading to unnecessary fuel consumption, noise, emissions, and environmental hazards. While static battery systems co-located at a solar site can store surplus power, their immobility does not allow for delivering energy to remote consumers at premium rates.

### DEFINITIONS

As used in this application, the following terms and acronyms shall have the meanings set forth below. Where the definitions conflict with ordinary meaning, the definitions herein shall control for purposes of this invention.

DONKEY (Deployable On-site Node for Kinetic/Electrical Yoke): A mobile or semi-autonomous support platform that operates in conjunction with the MULE to assist in the deployment, positioning, and transport of battery units or mechanical equipment. The DONKEY includes an onboard battery and hydraulic powerpack and may support lifting, drilling, hauling, or rotating payloads via standardized yokes, hydraulic fittings, or electrical connectors. It may also perform site energy distribution and logistics operations autonomously or via remote control.

EV (Electric Vehicle): A road-capable vehicle propelled entirely or partially by an electric motor powered by onboard batteries. In the described system, the MULE serves as a specialized EV with dual-purpose capabilities—vehicle propulsion and stationary energy delivery.

MULE (Mobile Utility for Logistics and Energy): A mobile energy delivery platform that integrates a high-capacity traction battery with a vehicle chassis (such as a Class 6 truck) to provide both vehicle propulsion and external power delivery. The MULE is capable of delivering high-voltage DC and three-phase AC electrical power to remote or off-grid locations and is designed to support predictive energy deployment, just-in-time charging, and coordinated dispatch through a cloud-based control system. The MULE may include regenerative braking, modular power electronics, and various offloading mechanisms for battery deployment in the field.

PCS (Power Conversion System): A system of hardware and control electronics that converts the form of electrical energy stored in the battery (typically DC) into another usable form (typically AC). The PCS may also include capabilities for variable frequency and voltage control, allowing dynamic support of industrial loads and motor start sequences without requiring separate generator sets or variable frequency drives (VFDs).

PPA (Power Purchase Agreement): A contractual arrangement under which an energy consumer agrees to purchase electricity from a producer (e.g., a solar field owner) at a pre-agreed rate. In the context of this invention, PPAs may be location-and time-sensitive and facilitated via the control platform to stimulate development in underserved regions.

PSA (Power Sale Agreement): A general term for an energy delivery agreement, potentially used for ad hoc, temporary, or mobile energy sales. PSAs under this invention may be created dynamically by the control system in response to forecasted demand spikes or customer requests.

PTO (Power Take-Off): An external power interface or connection point on the MULE platform that enables the delivery of AC or DC electrical power to external devices, machinery, or battery modules. The PTO may be configured for field selection of voltage, frequency, and current limits depending on the load requirements.

SOC (State of Charge): The current charge level of a battery expressed as a percentage of its total capacity. The MULE system utilizes SOC data for real-time operational decisions, predictive charge management, and remote diagnostics.

VFD (Variable Frequency Drive): A control device used to vary the frequency and voltage supplied to an electric motor. In the context of the invention, energy losses and system inefficiencies associated with unnecessary DC-to-AC and back-to-DC conversions through VFDs are minimized by directly supplying compatible DC voltage levels from the MULE battery to downstream devices.

### SUMMARY OF THE INVENTION

The present invention provides a mobile, modular energy delivery system, herein referred to as the MULE (Mobile Utility for Local Energy), which utilizes a high-capacity traction battery housed within a mobile platform—such as a truck or trailer—to serve both as a propulsion source and as a deployable energy node capable of delivering alternating current (AC) and direct current (DC) power to off-grid, remote, or emergency field environments. By leveraging shared power conversion hardware, the same traction battery that propels the vehicle can be reconfigured on site to supply high-voltage DC (e.g., 800-1000 V) or three-phase AC (e.g., 480-575 V), enabling flexible power delivery to remote equipment, storage systems, or energy-intensive tools. The system supports just-in-time charging strategies, regenerative braking, and on-site renewable integration (e.g., solar canopies), allowing the MULE to dynamically adapt to varying load demands while minimizing battery wear and logistical inefficiencies. Power delivery is further enabled through onboard or off-vehicle ports, allowing seamless energy transfers whether the battery remains attached or is offloaded using integrated hydraulic, mechanical, or modular jack systems.

To support continuous and scalable deployment, the MULE platform incorporates real-time control logic, predictive analytics, and cloud connectivity to coordinate route planning, charge cycles, and load prioritization across multiple field units. Through a mesh network and telemetry system, each MULE and associated battery module can share operational data including location, state-of-charge, load requirements, and equipment availability, enabling distributed site-level energy coordination without reliance on fixed infrastructure. Optional components include removable sub-chassis systems, motorized rotation platforms, auxiliary “carrot” batteries for minimal propulsion after offloading, and companion transport and handling vehicles such as the DONKEY (Deployable On-site Node for Kinetic/Electrical Yoke). These accessories enable battery swaps, remote mobility, and mechanical support for heavy battery modules, and they interface with standard electrical, hydraulic, and data fittings to perform tasks such as lifting, powering, or positioning other systems within the site.

The MULE architecture supports multiple embodiments for energy transfer and operational support, including full integration of power conversion systems within each battery module for plug-and-play operation, or centralized inverter skids for site-based AC output. Advanced routing and load-balancing software ensures optimal energy distribution by accounting for terrain, battery health, load forecasts, and local energy prices. Field survivability is enhanced through ruggedized casings, safety features such as grounding rods and fire detection systems, and optional climate control, lighting, and cable management components. The system also allows for autonomous or semi-autonomous deployment, making it particularly suitable for disaster response, industrial operations, or agricultural environments where flexible, efficient, and modular energy access is critical. Ultimately, the MULE transforms electric vehicle infrastructure into a robust, decentralized energy distribution platform.

The present invention introduces a novel business method that integrates mobile energy storage systems—such as the MULE platform—with a centralized pricing, scheduling, and dispatch system to transform how renewable energy is generated, delivered, and monetized. By coupling mobile battery units with predictive control software and location-based pricing algorithms, solar field owners are no longer limited to selling electricity to utilities at fixed rates or storing energy in stationary systems. Instead, they can deploy charged mobile batteries to high-value remote demand centers, enabling flexible and profitable energy transactions across geographically dispersed sites. Remote users, in turn, benefit from access to cleaner, quieter, and more controllable power than diesel generators offer, with options for AC or DC delivery, adjustable voltage and frequency outputs, and integration with pop-up solar shade structures that extend battery runtime.

The method enables solar developers and energy producers to capitalize on fluctuations in electricity pricing and demand by dynamically deploying mobile battery units to off-grid and underserved areas. A cloud-based control platform evaluates real-time data-including road access, energy demand, diesel fuel prices, weather forecasts, and battery availability-to optimize deployment routes and energy allocations. Mobile units may be offered under pay-per-use, subscription, or peak-capacity reservation models.

Additionally, the platform facilitates the development of solar projects in locations previously deemed uneconomical due to transmission constraints, as mobile batteries eliminate the need for costly utility interconnections.

The system can incentivize new projects or load centers by selectively adjusting pricing to promote energy consumption or generation in specific areas. End users gain guaranteed access to replacement battery modules during outages, and battery owners can receive compensation for participation in the mobile grid, creating a shared incentive model that reduces risk and expands energy access.

Beyond logistics and pricing, the invention contemplates a fully integrated energy ecosystem in which field equipment and battery modules share standardized power and data interfaces, enabling seamless plug-and-play operation across diverse industries. Pop-up solar arrays may be used as temporary generation and shading infrastructure at job sites, while optional support platforms such as the DONKEY enhance mobility and mechanical handling of battery units. The system also supports real-time transaction processing, state-of-charge monitoring, and market-based adjustments through a centralized cloud service. Altogether, this business method creates a scalable, data-driven framework that increases energy resilience, supports industrial electrification, and unlocks new revenue opportunities for renewable energy producers through flexible, decentralized, mobile energy distribution.

### BRIEF DESCRIPTION OF THE DRAWINGS

The accompanying drawings, which are incorporated herein an form a part of the specification, illustrate the present invention and, together with the description, further serve to explain the principles of the invention and to enable a person skilled in the pertinent art to make and use the invention.

FIG. 1 illustrates an exemplary system architecture in which a solar field charges mobile battery units that are dispatched to remote sites under the coordination of a central control platform.

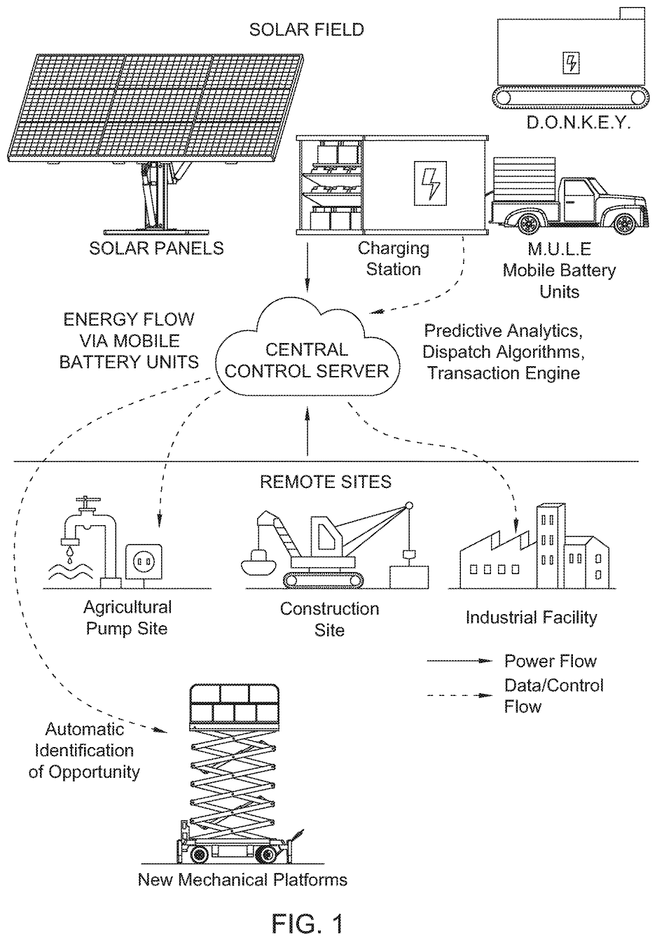

FIG. 2 provides a simplified flowchart showing how the system identifies off-grid energy demands, dispatches a battery unit, and completes billing after power delivery.

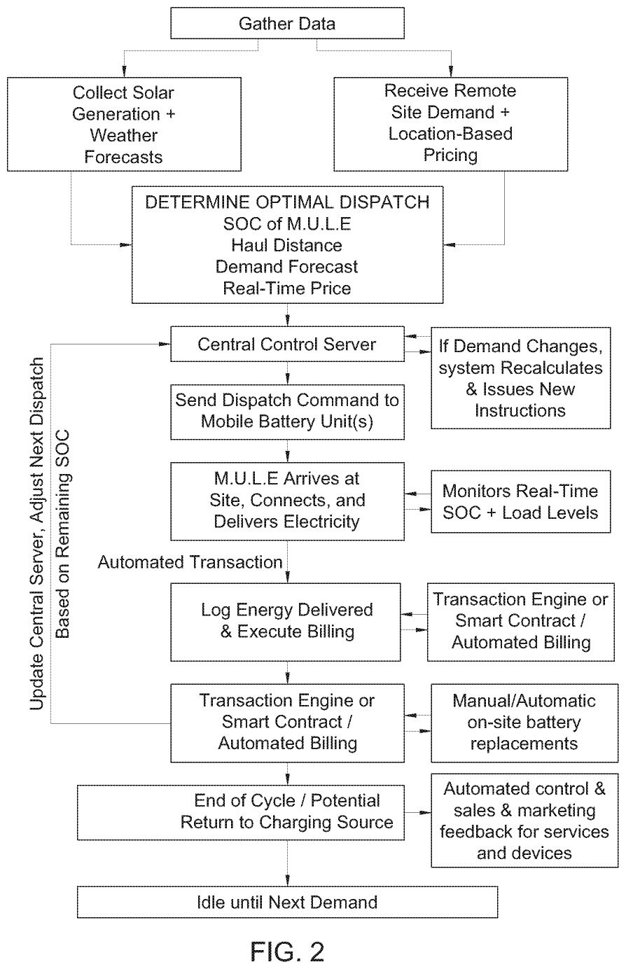

FIG. 3 depicts a schematic map revealing how location-based pricing accounts for transport costs and diesel-replacement rates to optimize energy delivery routes.

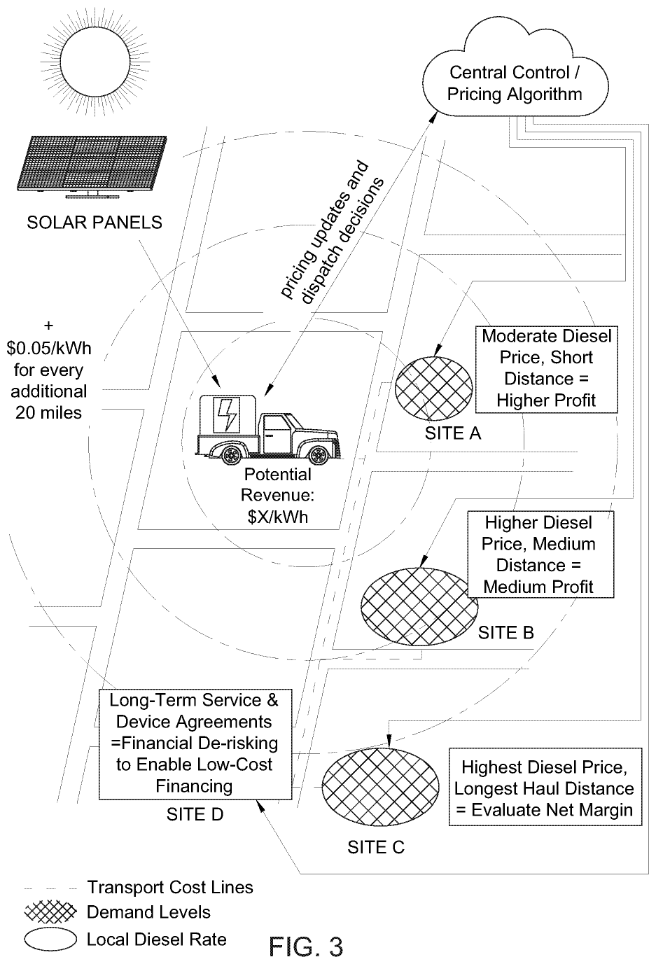

FIG. 4 shows a MULE vehicle with an integrated traction battery and power conversion unit, demonstrating how it supports both propulsion and external power output.

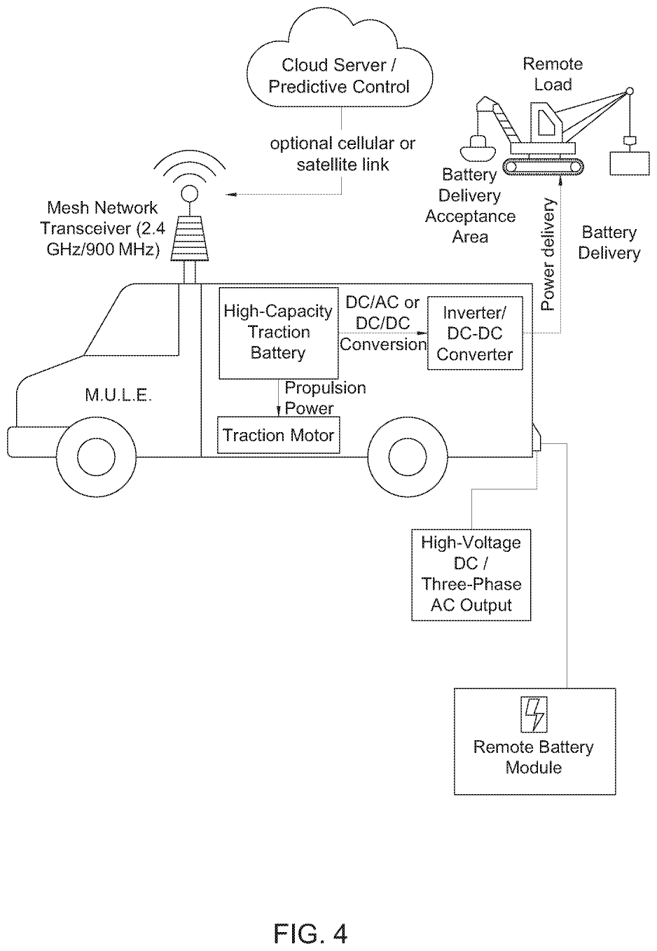

FIG. 5 demonstrates the predictive control logic and communication links that manage just-in-time charging and discharging for efficient energy allocation.

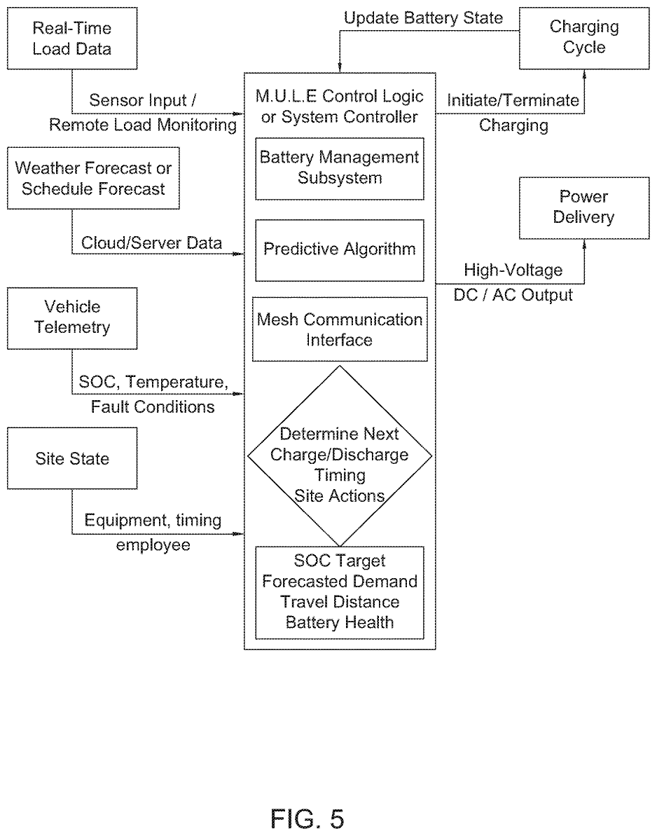

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced.

These embodiments are described in sufficient detail to enable those skilled in the art to practice the invention, but other embodiments may be utilized and logical, mechanical, electrical, and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention. Referring to the figures, it is possible to see the various major elements constituting the apparatus of the present invention.

A core concept of the MULE is that a single high-capacity battery in a truck or similar mobile platform can serve both as the vehicle's traction battery and as a field-deployable power source for external loads. By designing the power electronics to supply electricity in stationary or semi-stationary scenarios, the battery that normally propels the vehicle can seamlessly transition to delivering three-phase AC (commonly 480 V or 575 V but is not limited to these voltages) and high-voltage DC (in the 800-1000 V range but again not limited to this range). Similarly, the invention is optionally able to be charged in different ranges to accommodate different charging conditions (e.g. EV charging stations, common solar output configurations, etc.). This broad functionality leverages the same inverter or DC/AC conversion hardware used for driving, but repurposes it to feed stable power outward while the wheels remain stationary or partially active. The result is a mobile “power hub” that can drive to remote sites, connect to heavy equipment, pumps, or other battery modules, and deliver precisely the right amount of energy before returning to recharge or continuing its route.

To manage charging and discharging effectively, the MULE optionally employs both regenerative braking—recapturing energy during deceleration or downhill travel—and may be incorporated with an onsite solar energy and shade structure that improves site performance while reducing external power demand. The MULE system may incorporate an intelligent control system that monitors real-time load requirements, upcoming demand forecasts, and travel distances. Rather than lingering at or near full state-of-charge (SOC), the system can strategically time its charge cycles, reaching peak capacity only when needed. This practice, sometimes called “just-in-time” charging, helps minimize battery degradation and maximize overall efficiency. It also supports partial discharges, where the MULE transfers a portion of its stored energy to remote devices but conserves enough to ensure it can still travel to a recharge point.

Maximizing the delivery of useful power at the remote location is an important feature and creates demands for weight reduction of the MULE system. The MULE will frequently operate as a system to transfer power from a location where it has a lower value to another location where the value of the power is higher. Each step in the process of transferring energy from the source to the final useful work or service at the remote location has associated potential losses of total energy delivered. The maximum total vehicle mass, for example the 26,000 Gross Vehicle Weight rating described earlier for some driver license types, defines the maximum mass of the battery energy that the vehicle may carry in some embodiments.

There are protection and safety systems which in many situations are required such as a weather-proof housing, battery charge management system, a fire detection and prevention system and a thermal management system. In addition to these systems there must be an architecture to deliver the energy to the mobile battery and remove it from the battery and a sensor system to track and transmit state of charge, location, temperature, power input or output of the battery system and other useful information. Each of these systems may contribute to reductions in the total load capacity available for transporting energy.

A common feature of existing battery energy and storage systems is that they have an included Power Conversion System (PCS) that converts the direct current (DC) energy stored in the battery to alternating current (AC) energy. The AC power is usually produced at the fixed frequency of the local electrical grid. Efficient operation of machinery with electrical motors often requires the frequency of power to be changed dynamically at the demand of a signal provided by the operation or set at a different rate that reflects operational characteristics of the process. The starting frequency and voltage is often reduced to lower the surge of current when starting motors as one example. When grid power is used for industrial electrical equipment this frequency adjustment is done with a variable frequency drive. This device converts the AC energy first to DC within the device and then recreates an AC power source at a frequency that is user defined or automatically controlled. Each conversion from AC to DC or from DC to AC involves energy loss and is done with expensive, heavy equipment that may be subject to damage in a mobile operation.

Thus the default inclusion of a fixed frequency PCS system that converts DC to AC is wasteful if the ultimate process requires that a VFD device be utilized to convert back to DC and then convert again to AC with the process appropriate frequency. Not only is energy lost in conversion but more costly equipment is required and thus more equipment is susceptible to malfunction potentially compromising the work to be accomplished.

It is thus advantageous if the DC voltage of the battery system is within an appropriate range to meet the DC voltage requirements of the electrical system input used to create the controllable frequency AC power output.

When the vehicle functions like a portable generator on wheels, the system includes an external power port similar to a power-take-off (PTO). Through this interface, a user or automated controller can specify voltage levels and frequency, allowing the MULE to drive various industrial machinery or high-power applications in the field. By simply selecting the appropriate output parameters—such as 60 Hz at 480 V three-phase or other configurations—the existing power conversion system can provide the standard voltages and waveforms required to operate heavy equipment without relying on a separate generator. Likewise, in high-voltage DC mode, the MULE can bypass extra inverter steps and feed energy directly into battery modules designed to accept DC input. This direct DC coupling is especially beneficial when multiple standalone battery units are scattered throughout a site, as it reduces both equipment cost and conversion losses.

Communication and control are coordinated through a local mesh network that relies on 2.4 GHz or 900 MHz wireless transceivers to share data on battery status, load demand, and module availability. In a remote or emergency scenario where wired infrastructure may not exist, each MULE and any deployed battery modules can still exchange enough information to optimize which MULE needs energy and when. The mesh arrangement ensures that even isolated modules, or ones placed far from a centralized control unit, can remain in contact so long as each node is within range of at least one other node. For higher-level coordination, such as retrieving weather forecasts or scheduling multi-day energy delivery plans, the MULE can connect to a cloud-based service via cellular or satellite link. This allows for route optimization—determining which loads to visit first or when to recharge during off-peak utility hours—and for predictive maintenance by spotting anomalies in battery health over time.

The notion of “just-in-time” energy management expands naturally once connectivity extends to the cloud. Instead of maintaining a perpetually full battery for unpredictable loads, the MULE or its remote server can forecast likely demand patterns (for instance, pumping water at dawn or running construction equipment midday). By aligning final charge cycles to match those demand peaks, the vehicle's battery avoids unnecessary wear and can share real-time updates with all on-site machinery or battery modules via the mesh. Should conditions shift unexpectedly—such as a sudden increase in equipment usage or an unplanned outage—the MULE recalculates its remaining range and available kilowatt-hours, then dynamically adjusts its discharge plan. This ensures a more flexible, efficient, and fault-tolerant approach to supplying power on location.

In practical terms, this system proves invaluable in several operational scenarios. For emergency response, the MULE can travel into disaster-stricken areas and power essential pumps, refrigeration units, or communication gear for extended periods without the noise, emissions, or refueling demands of a diesel generator. When capacity drops, it can drive back to a stable power source or a refuel station—if it's a hybrid platform—to recharge and quickly return to the field. Likewise, at a construction or agricultural site, heavy machinery that ordinarily relies on separate generators or the grid can run directly from the MULE's three-phase AC interface. Portable battery modules for lighting, sensors, or auxiliary gear can be distributed around the work area, with the MULE topping them off via quick high-voltage DC transfers. In agricultural or mining applications, where power-hungry loads may be spread across large distances, the MULE simply navigates to whichever locations require energy, benefiting further from regenerative braking when descending hills or slopes.

In one embodiment, the traction battery can be offloaded using a series of manual or motorized jacks integrated into the battery housing. When the MULE arrives at a desired location, these jacks lower the battery onto the ground and allow the vehicle to drive away, enabling standalone operation of the battery module as a stationary power source. This approach eliminates the need for external lifting equipment, making it particularly valuable in rugged or remote environments where forklifts or cranes may be unavailable. The jacking system can also be configured to raise the battery back into place when the MULE truck returns, thus providing a quick and safe method for battery swapping or on-site deployment.

In another embodiment, the traction battery is mounted on a removable sub-chassis that locks to the main vehicle frame via heavy-duty pins or clamps. When the battery is to be swapped or used off-vehicle, a small auxiliary battery or external power source supplies just enough energy for the MULE to disengage the lock, drive off, and reposition itself under a fresh sub-chassis containing a fully charged battery. This method allows for near-continuous operation of the MULE by minimizing downtime and ensures that large-capacity batteries can be swapped out rapidly—especially useful in busy construction sites or disaster recovery scenarios requiring high-frequency energy delivery.

In certain embodiments, the traction battery can be transferred on and off the vehicle using a rotating sub-chassis or turntable mechanism integrated into the truck's deck. Rather than requiring excessively wide stabilizing arms, the battery pack is rotated—up to 90 degrees or another suitable angle—so that powered jacks can lower it to the ground from the side. This approach allows the MULE to pull away cleanly without the need for heavy external lifts or forklift-style side rails, providing a simpler, more space-efficient offloading sequence. Additionally, the corner jacks themselves may embed grounding rods that press securely into soft terrain, enhancing safety in high-voltage applications by creating an immediate earth ground for the standalone battery. Where terrain is firm or paved, a dedicated grounding cable can be employed in lieu of physically driving rods into the ground.

Alternative configurations for removing the main battery include a roller-and-winch method, wherein a series of rollers beneath the battery and a winch on the vehicle enable the pack to slide on or off. This design can help accommodate uneven or muddy ground, as the heavy battery is moved horizontally with minimal friction. In any of these offloading scenarios, the hydraulic or mechanical actuation system may reside on the vehicle or be integrated directly into the battery housing. Placing the jacking hardware on the truck itself can reduce per-module complexity and cost, while self-contained jacks in each battery allow them to be offloaded even when multiple trucks or separate deployment sites are in use. Overall, these mechanisms support rapid swapping, stable positioning, and intuitive handling under rugged conditions.

Another feature relevant to extended field operations is the option to include a smaller, auxiliary “carrot” battery in parallel with the high-capacity traction battery. This auxiliary pack ensures the MULE can continue to drive once the main module is removed and placed at the work site, allowing for near-continuous shuttle service of multiple battery units. Although a separate auxiliary battery adds mass and complexity—particularly with respect to its own battery management and power electronics—it may be beneficial where continuous rotations are essential or where the main battery needs to be entirely dedicated to external load demands. By contrast, a single large battery is the simplest embodiment and often maximizes the ratio of usable energy to overall vehicle weight.

In another embodiment a trailer or “cart” can be connected to the MULE truck when it arrives at the placement site that incorporates a battery large enough to allow movement of the MULE truck around the site while battery modules are off-loaded and on-loaded. This device may optionally include a hydraulic system with a quick-connect hose assembly that can be attached to the legs of the battery module to raise and lower them or optionally to power a battery module rotation mechanism, ground anchoring system or lift and place solar shade and power panel modules. The cart can optionally supply lighting power and 120 v or lower voltage ac power by incorporating a DC to AC converter. The cart can optionally be a powered vehicle, for example a tracked chassis that can move without contribution from a separate vehicle under autonomous, remote, on-board driver or walk-behind or walk-beside driver.

In one embodiment, a propelled vehicle can serve as a generalized on-site work platform by carrying both electrical power (in a battery) and hydraulic fluid. This vehicle, known as the Deployable On-site Node for Kinetic/Electrical Yoke (D.O.N.K.E.Y. or DONKEY), can function as a kinetic platform through its included hydraulic powerpack—optionally driving wheeled or tracked configurations—while connecting to a wide range of actuator systems via standardized connection points or yoke, standard electrical power connections and quick-connect hydraulic fittings. These fittings enable diverse operations such as lifting, digging, drilling, pulling, or pushing. They also allow the DONKEY to serve as a transport platform for mobile batteries, which it can help unload from the MULE. By using the DONKEY's onboard battery, the MULE truck can move after disconnection so the battery can be unloaded, while the DONKEY's onboard hydraulics raise, lower, or rotate the necessary actuators for handling the battery unit. Once detached, the battery unit can be carried by the DONKEY or placed in another advantageous position.

Beyond unloading, the DONKEY in its mobile embodiments can transport and exchange batteries at various power consumption points—such as those with pumps or grinders—and then return discharged batteries to the MULE truck for reloading. Each battery may be fitted with extendable legs that lift it from or lower it onto the DONKEY's deck, using the kinetic power/hydraulic fluid system the DONKEY incorporates. A series of communication and control frameworks, shared between the DONKEY and the MULE, supports coordinated data gathering on both status and site logistics. Together, this coordinated platform moves battery energy to and from a site (and within a site) while also enabling a wide variety of tasks through the DONKEY's suite of modular accessories. The DONKEY can optionally additionally have autonomous control systems hosted on local networks and/or through cloud interfaces. Additionally, may include IR/LIDAR or other forms of motion tracking to be able to guide movement planning/controls.

The MULE when used in conjunction with a DONKEY yields a site energy distribution system which can optionally include a solar generation system on site to provide power production and optionally give shade to reduce solar damage or heating of on site equipment. A separate purpose of the overhead shade and solar array may be to carry power and data cables above avoiding damage and enhancing safety of on site wiring.

The MULE power electronics suite can likewise be modular. Certain implementations have a comprehensive power conversion system on each battery, so off-vehicle operation requires minimal additional hardware. In other embodiments, a central inverter skid or on-site power conversion module may be stationed remotely, reducing the weight each MULE must carry. Where multiple MULE batteries are deployed in parallel at a large site, a local management algorithm can selectively discharge or recharge individual packs, prioritizing one battery to empty first if it needs to be swapped out soon, while another remains only partially discharged to optimize battery lifespans. This load-balancing logic can also account for differences in battery ages, chemistries, or states of health, thereby extending the service life of each unit.

Beyond fundamental charging and discharging functionality, various mechanical and safety accessories may be integrated. For instance, an overhead cable harness or retractable boom can lift power leads above ground level, preventing them from becoming obstacles for foot traffic or construction vehicles. The same structural arms may double as mounting points for basic shade awnings or even auxiliary solar panels, providing a trickle charge and reducing the battery's thermal load in extremely hot climates. For nighttime or emergency scenarios, each battery unit may include LED lighting arrays, plus onboard cooling or heating that can be harnessed to create a small climate-controlled workspace. Such features reinforce the MULE's value as a comprehensive, self-sufficient power hub in remote or off-grid environments.

Operational logistics can be optimized via predictive scheduling and real-time telemetry. By analyzing travel distances, terrain elevation, load requirements, and forecast data, the system tailors each MULE's state-of-charge to arrive precisely when needed—averting both unnecessary battery wear and the downtime associated with returning for an earlier-than-necessary recharge. The software can dynamically update these plans in response to sudden load spikes or changes in user demand, for example rerouting a partially discharged unit if the site already has enough capacity. This same predictive logic informs the distribution of multiple battery modules, ensuring they do not all draw down simultaneously and helping align final charge cycles with the highest-value usage windows. Taken together, these expanded embodiments and design considerations illustrate how the MULE platform can deliver maximum efficiency, safety, and adaptability in a wide array of remote energy scenarios.

In certain embodiments, the vehicle platform is built on a Class 6 truck chassis with a gross vehicle weight (GVW) at or below 26,000 pounds, ensuring that operators can drive it without specialized licensing in many jurisdictions. To maximize the allowable payload for the traction battery, the chassis may be optimized by reducing wheelbase length, using lighter-weight frame components, or minimizing non-essential hardware. Such measures allow the MULE to carry a larger battery system within legal weight limits, thereby maximizing off-grid energy capacity while preserving highway drivability. Although any truck class may be used, these mid-range platforms strike an attractive balance between substantial battery payload and accessible permitting requirements.

While the simplest embodiment of the MULE has one large traction battery for both propulsion and external power delivery, an alternate embodiment adds a smaller “auxiliary” or “carrot” battery. This secondary pack remains onboard the vehicle after the main pack is offloaded, enabling the MULE to continue driving for recharging operations or other logistics tasks. Although a dual-battery design can increase weight, cost, and complexity (as both packs require individual battery management subsystems and discharge rates must be balanced), it may be advantageous for fleets that need continuous energy rotation without leaving the vehicle immobile at a remote site.

In multi-unit deployments, the system may incorporate fleet-wide coordination logic so that individual battery modules or entire MULE vehicles can share load data and optimize energy distribution. For example, when three modules are positioned at a job site, one might be preferentially discharged first to prepare it for an upcoming swap, allowing the other two to remain partially charged for ongoing needs. Such orchestration is especially useful when modules have varying states of health or different lithium-based chemistries, and when long-term forecasts or route constraints dictate strategic charging windows. Real-time telemetry allows continuous re-allocation of power resources in the field, further enhancing efficiency and uptime.

The invention contemplates multiple ways to detach the traction battery from the vehicle platform. One approach places the pack on a rotating sub-chassis or turntable integrated with the truck's deck; the battery can pivot up to 90 degrees, after which built-in jacks lower it safely to the ground. This eliminates the need for wide lateral arms and accommodates tighter parking spaces. Another approach relies on rollers beneath the battery plus a truck-mounted winch, enabling operators to slide the pack on or off, even on uneven terrain. In either case, each battery corner may house a jack that also doubles as a grounding rod driver, providing immediate earth grounding for safe high-voltage operation. Where the ground is too firm or paved, a conventional grounding cable may be connected instead.

Depending on operational priorities, the hydraulic or mechanical actuation needed for offloading may reside entirely on the truck or be integrated into the battery modules. Centralizing the lifting hardware on the truck simplifies each individual battery—lowering its production cost and weight—yet requires bringing the equipped truck whenever offloading is necessary. Conversely, self-jacking battery modules can be dropped off or picked up by virtually any flatbed vehicle, albeit at the cost of extra mass, complexity, and higher theft risk if the jacks can be deployed without authorization. Either embodiment improves the speed, safety, and simplicity of battery swaps in remote or rugged environments.

Additional flexibility may be obtained by designing the power electronics as modular, swappable units. In one scenario, each battery contains an onboard power conversion system (PCS) and inverter, allowing true plug-and-play operation wherever it is dropped. Another scenario uses one or more centrally located PCS skids that multiple battery modules can connect to in parallel. This reduces weight on each MULE at the expense of needing a dedicated inverter station in the field. Hybrid configurations are also possible, where batteries carry a basic or partial power stage while supplemental inverters are connected at a larger site for bulk AC output.

The MULE platform's onboard control logic continuously forecasts both driving distances and load demands, timing each charge cycle so the traction battery is at peak state-of-charge only when needed. This “just-in-time” charging approach minimizes the time spent at or near 100 percent SOC, mitigating battery degradation. Cloud-based or satellite-linked software can further refine these schedules, updating routes or reassigning modules if traffic congestion, unexpected load spikes, or weather shifts alter energy requirements. In this manner, even a small fleet of MULE vehicles can allocate stored power precisely, adapting routes and charge-level targets in near real time.

To improve reliability and user safety in the field, each battery unit may be equipped with auxiliary accessories such as a retractable overhead cable harness for keeping power leads off the ground, integrated LED work lights for nighttime operation, and optional climate-control elements for emergency shelter. Where high ambient heat risks degrading battery performance, a solar-panel canopy can be deployed over the battery module, providing both shade and a low-rate recharge. Additionally, onboard sensors—potentially including thermal cameras, LIDAR, or vibration monitors—allow predictive maintenance and automated terrain navigation, ensuring each MULE module remains robust under demanding off-grid conditions.

Looking to the future, the architecture also lends itself to autonomous or semi-autonomous operation. After receiving instructions from a remote scheduler, the MULE could be dispatched to carry and deliver power across a large site in a completely self-directed manner. It might coordinate with on-site sensors or other vehicles to determine when a job has finished, automatically rerouting if new requests for power come in through the local mesh or cloud portal. This removes much of the manual guesswork from energy logistics, potentially reducing downtime, fuel costs, and the number of redundant power systems needed. Ultimately, the MULE concept merges the mobility of an electric vehicle with the robust power-delivery needs of remote and off-grid operations, creating a dynamic and efficient solution to real-world energy challenges.

The present invention introduces a novel business method that ties the mobility of specialized battery systems (for example, the “MULE” platform) with a cohesive pricing, scheduling, and deployment framework. By doing so, solar field owners are no longer limited to stationary storage or utility offtake agreements; instead, they can deploy mobile batteries to high-value demand centers, thereby unlocking new revenue. End users of power in remote areas benefit by renting or buying access to clean, mobile power precisely when it is needed, mitigating diesel reliance. The mobile battery power affords remote users expanded capabilities in comparison to standard diesel power systems including the opportunity to consume the power efficiently through a wide range of power consumption rates, the ability to use on-site solar panel augmented shade systems to extend power duration, the ability to vary the delivery frequency and voltage to ensure machines operate at the most efficient speed and reduced motor start current surges.

These value enhancements in comparison to diesel ensure that delivered battery power is attractive even if priced at parity with on-site diesel. This integrated approach reshapes the economics of both energy generation and consumption, creating a more flexible “mobile grid.” with a wider range of power prices that are mutually acceptable to buyers and sellers.

A cloud-based central control server can track, plan and predict power supply and demand while using location-based pricing within this wider mutually acceptable pricing range to drive supply or demand side changes in power markets toward more stable or profitable outcomes.

This invention centers on a business method in which solar field owners and other distributed energy producers can monetize power through the use of mobile battery systems, thereby serving off-site customers at premiums that exceed typical utility contract rates. In one embodiment, solar developers-who generally have access to relatively low-cost financing-own or co-own mobile battery units that can be charged at the solar site. Once these batteries are fully or partially charged, they are dispatched to remote or off-grid locations where electricity demands, often met historically by diesel generators or diesel equipment such as a diesel powered pump, present an opportunity for more profitable transactions.

A market dynamic that drives grid-connected solar field owner economics is called the “duck curve” representing the over-supply of grid-connected electricity generating capacity during the afternoon when solar and wind generation peaks and the reduced availability of energy when the sun sets but demand rises as people return from work and turn on appliances or start vehicle charging at home. Utilities reflect this with peak versus off-peak pricing to customers and by paying their electricity suppliers more during some periods and paying them much less at other times. Some electrical providers can shut off their production of energy but others like solar field owners cannot; this characteristic is called “dispatchability”. Gas turbine power generators are more dispatchable than solar fields, wind farms or biomass power plants.

When a curtailment order is received due to electrical oversupply typically at midday in late spring or early summer, the solar owners instead reduce the amount of energy sent to the grid and it is dissipated as heat from the panels. Electrical suppliers sometimes oversupply to the grid for a variety of reasons and can be subject to charges.

The result of this economic incentive is to create a distinct value associated with an empty (discharged) battery just as the energy in a full battery is valuable. Each type of battery state of charge has a location and time dependent value that may be optimized by a cloud-based logistics system using data and predictions. A key component of this business method is the ability to site renewable energy production in regions not served by conventional transmission infrastructure. Because power can be exported in mobile battery units, developers are no longer constrained by proximity to grid tie-in points. This flexibility allows solar arrays (or other renewable resources) to be built atop optimal terrain—such as sloping south-facing fields—regardless of how distant they may be from utility lines as long as adequate road access is available or included in the project plan. The otherwise prohibitive cost of building new transmission is circumvented by loading the generated power onto mobile battery modules, thereby transforming geographically isolated sites into viable clean-energy producers.

When the cloud-based control system identifies a location that would be a desirable off-grid energy production location in an underserved mobile power supply area, marketing and sales may target property owners in the area offering power purchase agreements (PPA) that property owners might use to secure low-cost debt financing. The system may offer these PPA's at a higher or lower rate to incentivize the most profitable outcomes. When an existing solar field might be expanded the expansion may be incentivized in a similar way.

The cloud-based control system will from time to time predict or observe that increased demand in an area might be more profitable. This creates alternatives to provide power sale agreements (PSA) to businesses or contractors that might choose to engage in power consuming activities such as wood chipping, forest thinning, or water movement that have time and geographic restrictions. Additionally modular equipment systems based on the deployable on-site node for kinetic/electrical yoke (DONKEY) which are designed to couple with the mobile utility for logistics and energy (MULE) may be made available for rent or purchase at more advantageous rates restricted by time and geography.

The method leverages two key insights to increase value for all parties involved. First, it recognizes that end users in the field usually face constraints when operating diesel generators. These users often oversize their generators to accommodate infrequent but high-load conditions, thereby incurring unnecessary capital expense, fuel costs, and logistical complexities. By using a mobile battery system, off-grid sites can fulfill peak loads with greater ease while lowering noise and eliminating the risk of fuel spills—an important factor in ecologically sensitive areas or sites subject to strict environmental regulations. Second, the solar field owner gains the ability to sell electrons to multiple customers, rather than entering a single-buyer agreement with the utility. In turn, this dual-market approach elevates the potential return on investment for the energy producer.

Moreover, the method supports a “dual-market” strategy: if off-grid or remote demand temporarily wanes, solar field owners can still sell unused generation to traditional utility buyers. In this way, the mobile battery fleet does not lock a developer into a single revenue path. Instead, an intelligent dispatch system will evaluate real-time market data—such as local diesel prices or industrial load spikes—and instantly allocate storage resources to the highest-value demand, whether that is a nearby construction project, an isolated farm, or the utility grid itself.

In another application of the control system an evaluation of the locations of vehicle charging systems may identify either on-grid or off-grid generation adjacent locations advantageous for new charging stations but with insufficient projected demand to justify the capital expenditure. The control system may recommend augmenting the demand with a PPA with the candidate vehicle charging station owner. This leverages the electric vehicle charging network to support the mobile utility network in a synergistic arrangement.

At the heart of this method is the “MULE” or an equivalent mobile energy platform that draws power from a photovoltaic installation, another renewable energy source, or optionally from the utility grid. Once charged, the platform can deliver both high-voltage direct current (DC) and three-phase alternating current (AC) to heavy machinery, auxiliary batteries, or other field loads. To optimize deployment, the system employs predictive analytics and location-based pricing. Market data, including transportation distances, local electricity scarcity, and demand patterns, inform which battery unit should be dispatched to which field load. An operator or an automated control system calculates where the highest-value need exists, dispatches the mobile batteries accordingly, and processes the resulting transactions in a real-time or near real-time manner.

The heart of this off-grid business model lies in identifying “hot spots” where energy commands a premium. A specialized software platform analyzes road networks, seasonal events, known industrial operations, and other factors to pinpoint when and where mobile power can fetch the best price. As demand at one location subsides—say, after a job site completes—battery units can be re-routed to new areas experiencing elevated load, such as a forestry thinning operation or a well-drilling site. This agile allocation of power, guided by real-time logistics data, ensures continuous utilization and strong economic returns for solar producers.

The mobility of the battery units is further enhanced by the standardization of their power ports and data communication interfaces. Under this invention, both the mobile battery system and the field equipment it serves are designed to interact seamlessly, often through a common voltage range and a universal connector. This uniform interface allows a single battery fleet to service diverse industries—from agriculture (irrigation pumps) to construction (heavy-duty machinery) and even temporary disaster-relief sites (medical refrigeration or water purification). By removing the compatibility barriers that typically hinder large-scale adoption, the business method supports a broader, more integrated marketplace for off-site energy delivery.

Additionally, remote solar installations can double as electric-vehicle (EV) charging hubs. By maintaining battery units on-site, the same infrastructure that supplies off-grid industrial loads can provide quick-turn charging services for passing electric vehicles. Should local EV traffic be insufficient to consume the available generation, the system retains the option to dispatch mobile batteries elsewhere. This arrangement mitigates the risk of underutilized EV-charger installations and amplifies revenue opportunities by uniting vehicle charging with transportable energy resources.

The mobile battery network is advantageous because the batteries are an attractive way to encourage a variety of users to invest in battery purchase in order to place the batteries in the service of the control system in exchange for a payment based on the utilization of the battery by the system. This arrangement can be made more attractive by guaranteeing that in the event of a local power shortage an equivalent charged battery will be delivered to the specified location where the outage has or will occur. In this way battery owners can be assured of protection from outages in the same way that a back-up natural gas, propane or diesel generator might protect them but without the maintenance and with a superior level of power and comfort. Local governments or organizations may choose to partner with owners and the control system to provide district back-up power.

In another aspect of the method, temporary or “pop-up” solar arrays can be deployed at job sites. Used or decommissioned solar panels, which still retain functional capacity, may be set up as shade structures for the mobile battery units. The canopy formed by these panels not only protects the batteries from excessive heat, thereby prolonging their operational life, but also generates onsite power to recharge them.

In scenarios where electricity is valued at higher than standard grid prices, this approach can provide a rapid payback period for the panels while simultaneously lowering overall operating costs. By coordinating the pop-up panels with the dispatch schedules of the mobile battery units, a flexible microgrid emerges—one where surplus energy can be quickly delivered to new locations as projects conclude or demand shifts.

A further dimension of this business method is its potential to reshape how industrial machinery is powered. Instead of requiring each piece of equipment—such as wood chippers, irrigation pumps, or drilling rigs—to carry a dedicated diesel generator, operators can adopt simpler, electric-driven devices designed around standardized battery inputs. When mobile battery units arrive at the field, they seamlessly link to these electric devices, providing robust power on demand. Because electric motors are more efficient at variable loads and can idle without consuming appreciable energy, overall fuel costs, emissions, and noise pollution drop significantly compared to diesel-based operations.

The business method further envisions an automated transaction workflow. A central platform or cloud service can record each energy sale, maintain a ledger of battery state-of-charge information, and handle pricing adjustments based on market fluctuations and real-time usage data. Solar field owners, in cooperation with the operators of the mobile battery fleet, may implement subscription-based or pay-per-kWh billing models. In some embodiments, a pay-per-capacity approach is utilized, allowing field users to reserve a certain amount of peak power capability for specific time windows. Such a model aligns with sectors where occasional bursts of high power demand are critical, but continuous generation is not required.

The method likewise accommodates industries with highly variable or seasonal power demands. For instance, a farm that floods and drains fields on a rotating schedule can temporarily lease or purchase mobile battery capacity only during peak pumping periods. If a forestry service ramps up logging or wood-chipping for a short season, the service can arrange for multiple battery units to arrive on-site. Once that window ends, these units are free to relocate to a different region, industry, or use case, avoiding long-term idle capacity that would otherwise undermine profitability.

Overall, this method reshapes the traditional supply chain of electric power. Solar fields become the primary generation source, mobile battery units become the transport mechanism, and remote industrial or agricultural sites become distributed consumption points. The monetary transactions are executed not solely through the sale of electricity back to the grid but through direct, market-based negotiations with end users who benefit from higher power quality, cleaner operations, and cost savings compared to diesel. Because the solar developer's cost of capital is typically lower than that of smaller or remote operators, it proves economically sensible for the solar developer to invest in—or co-invest in—the mobile battery systems. This creates a cycle in which the developer has a stake in both production and delivery, allowing for sophisticated strategies to maximize margins by delivering stored power to the most profitable demands at any given time.

From a commercial standpoint, each mobile battery dispatch accumulates valuable data on real-world energy consumption, transport routes, and local operating conditions. This historical record enables predictive analytics—refining forecasts, revealing untapped markets, and steering future decisions on where to place pop-up solar arrays or how to price deliveries. Such intelligence offers both solar field owners and remote end-users greater certainty, reducing capital risks and expediting the shift toward scalable, flexible clean energy deployments.

A central feature of this business method is the recognition that mobile battery power can be markedly better than diesel-sourced power for remote or high-demand applications. Because batteries do not require continuous fueling, produce minimal noise, and eliminate the risk of fuel spills, users realize significant logistical, environmental, and operational advantages over conventional generators. At the same time, solar field operators enjoy low marginal costs of production, particularly when existing land or subsidized renewable assets are utilized. These two factors—higher user value and lower generation cost—create a wide pricing range within which market participants can negotiate. As a result, the platform can selectively skew price signals, offering more attractive rates in locations where solar developers wish to encourage new projects or granting steep discounts to incentivize customers to switch from diesel.

By harnessing this broad range of acceptable price points, the method can effectively guide where and when off-grid projects are initiated. If a particular region stands to benefit from expanded renewable capacity, the system can temporarily elevate the premium paid to solar producers in that area, enticing them to develop new fields or install additional panels. Conversely, on the demand side, a remote mining or agricultural operation might be offered ultra-low-cost battery power during its start-up phase to encourage the adoption of electric-driven machinery. Because all financial transactions, dispatch instructions, and dynamic pricing updates flow through a centralized market engine, operators can precisely manipulate incentives—both supply and demand—to stimulate renewable development in desired geographies and orchestrate energy consumption patterns that align with overall system efficiency.

In conclusion, the described business method achieves multiple objectives. It enables solar field owners to diversify revenue streams beyond a single-buyer utility model. It provides for remote operations a clean, flexible, and efficient alternative to diesel. It coordinates fleet dispatch based on real-time data, offering a system of standardized connectors and pricing mechanisms that facilitate frictionless energy transactions. By bridging the gap between renewable energy generation and the geographically dispersed points of high demand, this approach paves the way for a dynamic, decentralized market in which energy is routed to where it is most valued, with the entire process organized under a coherent, standardized framework.

Taken together, these elements evolve into a cohesive ecosystem where solar arrays can be installed far from the grid, mobile batteries transport the generated power, and end users can reliably purchase exactly what they need through an automated exchange platform. Contracts may be structured on a per-kWh or subscription basis, with location-and time-based pricing that incentivizes efficient logistics. This diversified approach safeguards investors, ensures high battery utilization, and paves the way for broad-based industrial electrification—while harnessing underutilized renewable generation that would otherwise remain stranded due to transmission constraints.

The system and method of the present invention is set to run on one or more computing devices, mobile electronic devices, or a combination thereof. A computing device or mobile electronic device on which the present invention can run would be comprised of a CPU, storage device, keyboard, monitor or screen, CPU main memory and a portion of main memory where the system resides and executes. Any general-purpose computer, smartphone, or other mobile electronic device with an appropriate amount of storage space is suitable for this purpose. Computer and mobile electronic devices like these are well known in the art and are not pertinent to the invention. The system can also be written in several different languages and run on a number of different operating systems and platforms.

Although the present invention has been described in considerable detail with reference to certain preferred versions thereof, other versions are possible. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

Thus, it is appreciated that the optimum dimensional relationships for the parts of the invention, to include variation in size, materials, shape, form, function, and manner of operation, assembly and use, are deemed readily apparent and obvious to one of ordinary skill in the art, and all equivalent relationships to those illustrated in the drawings and described in the above description are intended to be encompassed by the present invention.

Furthermore, other areas of art may benefit from this method and adjustments to the design are anticipated. Thus, the scope of the invention should be determined by the appended claims and their legal equivalents, rather than by the examples given.

1. A mobile energy delivery system, comprising
a vehicle platform having at least one traction motor and a traction battery configured to propel the vehicle platform;
a power conversion unit operably connected to the traction battery and configured to deliver electrical power to the traction motor for propulsion and convert power from the traction battery into at least one external output selected from the group consisting of high-voltage direct current (DC) output and three-phase alternating current (AC) output;
an external connector coupled to the power conversion unit for supplying the external output to one or more off-vehicle loads; and
a battery management subsystem that monitors a state-of-charge, temperature, and fault conditions of the traction battery and selectively controls power flow to the traction motor or the external connector, wherein the vehicle platform is configured to deliver energy off-site without requiring a separate, dedicated power-generation system and is further capable of driving to and from a charging station on stored battery energy alone.

2. The mobile energy delivery system of claim 1, wherein
the power conversion unit further comprises a bidirectional inverter configured to support both vehicle propulsion and external energy delivery by dynamically routing power between the traction battery, traction motor, and external connector based on a control signal from the battery management subsystem.

3. The mobile energy delivery system of claim 1, wherein
the external connector includes at least one interface selected from the group consisting of a Combined Charging System (CCS) port, a CHAdeMO port, and a three-phase industrial AC connector, adapted to couple with external energy-consuming devices or infrastructure.

4. The mobile energy delivery system of claim 1, wherein
the battery management subsystem includes a wireless communication module configured to transmit real-time diagnostic and performance data to a remote monitoring platform and receive remote control commands for directing energy flow priorities.

5. The mobile energy delivery system of claim 1, wherein
the vehicle platform is an electric truck chassis adapted for modular deployment; and
the power conversion unit and external connector are housed within a removable enclosure mounted to the chassis for ease of maintenance and adaptability across different mobile energy deployment scenarios.

6. A method of operating a mobile energy delivery system, the system including
a vehicle platform with a single high-capacity traction battery for both propulsion and external power output, the method comprising the steps of
determining a projected power demand for at least one off-vehicle load based on historical data, real-time sensor information, or predictive analytics;
controlling charging of the traction battery so that it reaches a target state-of-charge substantially before or at the time the projected power demand is forecasted to occur;
driving the vehicle platform to a remote location associated with the off-vehicle load using the traction battery to propel the vehicle;
supplying electrical power from the traction battery to the off-vehicle load via a power conversion system that provides at least one of a high-voltage DC output or a three-phase AC output; and
limiting discharge of the traction battery to retain sufficient state-of-charge for the vehicle platform to return to a charging source or complete additional assigned deliveries, whereby the traction battery is not continuously held at full state-of-charge, thereby reducing battery wear and enabling optimal, forecast-driven just-in-time power delivery.

7. The method of claim 6, further comprising the steps of
integrating a local mesh communication module into the vehicle platform, wherein the module is configured to form an ad-hoc wireless network with one or more remote energy storage units or load-monitoring devices, and
exchanging operational data via a wired or high-bandwidth interface between the mesh communication module and a system controller configured to manage battery parameters and power conversion functions.

8. The method of claim 7, further comprising the steps of
linking the system controller to a remote server or cloud-based service via a wide-area communication interface to receive predictive forecasts and coordinate charging schedules, and
executing control logic on the system controller to collect real-time data regarding battery state-of-charge, load requirements, or fault statuses, to selectively engage a power conversion path to supply high-voltage DC or AC output based on demand signals, and to synchronize charging and discharging schedules in accordance with the predictive energy models received from the cloud-based service.

9. The method of claim 6, further comprising the steps of
physically detaching the traction battery from the vehicle platform using a powered mechanical lift or sliding mechanism;
transferring the detached battery to a receiving surface or an alternative sub-chassis, wherein the detached battery remains capable of providing external power output while removed from the vehicle platform, and
monitoring and controlling the detached battery via a wireless or wired connection to the system controller or an auxiliary management interface.

10. The method of claim 6, further comprising the steps of
dynamically adjusting the vehicle platform's travel path based on input from geolocation and routing subsystems integrated with the system controller, the routing being responsive to real-time traffic data, battery state-of-charge, or updated load demand forecasts, thereby enabling prioritized and efficient deployment of stored energy to remote off-vehicle loads.

11. A method for dynamic allocation and forecast-based delivery of renewable energy to remote industrial loads using mobile battery units, the method being executed by at least one specialized computing platform in communication with a renewable energy generation source and a plurality of mobile battery systems, the method comprising the steps of
receiving, by the specialized computing platform, real-time generation data from the renewable energy generation source, wherein the renewable energy generation source is a solar field configured to produce electrical power;
collecting, by the specialized computing platform, load-demand information from a plurality of remote industrial sites, each site characterized by at least one off-grid or variable load;
determining, via a processor executing a location-based pricing algorithm, a ranked allocation of the electrical power among the plurality of remote industrial sites, wherein the algorithm calculates expected revenue for delivering energy to each remote industrial site based on transport distance for at least one mobile battery unit, forecasted load peaks, and real-time energy pricing that exceeds a benchmark utility rate;
dispatching instructions, by the specialized computing platform, to at least one mobile battery unit to transfer a portion of the electrical power from the solar field to a selected remote industrial site, the mobile battery unit being configured to store high-voltage direct current (DC) or three-phase alternating current (AC) power;
monitoring, by the specialized computing platform, a state-of-charge of the at least one mobile battery unit in transit and adjusting a route or delivery schedule in response to updated load-demand information or availability of additional renewable energy;
executing, via an automated transaction engine, a billing transaction between an owner of the solar field and an operator of the remote industrial site, wherein the amount charged is determined by the location-based pricing algorithm in accordance with the energy actually delivered by the mobile battery unit; receiving, by a centralized control server, forecast data related to solar power generation capacity, including at least one of weather predictions, historical production trends, and maintenance schedules for the solar field;
correlating the forecast data with anticipated energy demand profiles of multiple off-grid or remote operations, each having a known load pattern or equipment schedule;
identifying, via a predictive analytics module operating on the centralized control server, an optimal charging window for the mobile battery system, the charging window being determined by balancing predicted solar availability and cost-of-capital considerations; instructing a charging interface to initiate charging of the mobile battery system to achieve a target state-of-charge substantially prior to or concurrent with a high-demand period at a remote operation; routing the mobile battery system to the remote operation, wherein the mobile battery system includes a power conversion unit capable of outputting both high-voltage DC and three-phase AC power to off-vehicle loads;
supplying, via the power conversion unit, an amount of stored energy to the remote operation sufficient to handle a peak load condition or offset diesel generator usage, without exceeding a reserve energy threshold required for returning the battery system to a charging source; and
logging, in a distributed ledger or secure database, each dispatch event, power transfer, and billing transaction, thereby enabling an auditable record of forecast-driven mobile energy deliveries.

12. The method of claim 11, wherein
the predictive analytics module further adjusts the optimal charging window based on short-term weather fluctuations, solar array maintenance anomalies, and real-time changes in remote site energy consumption forecasts to improve delivery accuracy and energy yield efficiency.

13. The method of claim 11, further comprising the steps of
monitoring and controlling the power conversion unit to ensure phase synchronization and voltage compatibility with equipment at the remote industrial site, and wherein said control is coordinated through the centralized control server based on known electrical load characteristics of the destination.

14. The method of claim 11, further comprising the steps of
tagging each logged dispatch event with geolocation metadata, time of dispatch and delivery, and battery performance data to facilitate later analysis of delivery route efficiency, battery utilization trends, and operational reliability across different environmental conditions.

15. The method of claim 11, wherein the automated transaction engine computes billing based on actual kilowatt-hours delivered, duration of power provision, and additional modifiers including carbon offset credits generated by substituting renewable power for diesel-based generation at the remote industrial site.

16. A system for monetizing off-grid renewable energy deliveries, comprising
a solar field configured to produce an electrical output and communicatively coupled to a battery fleet management server, the solar field further comprising at least one charging interface configured to transfer electrical power to a plurality of mobile battery units;
a plurality of mobile battery units, each comprising a high-capacity traction battery, a power electronics module configured to convert stored energy into high-voltage direct current (DC) or three-phase alternating current (AC), a wireless communications module for receiving dispatch instructions, and a vehicular or trailer chassis configured to enable transport of the high-capacity traction battery over roadways or rough terrain;
a load monitoring subsystem deployed at one or more remote operations, the load monitoring subsystem being configured to measure real-time energy demands at each remote operation and transmit said demands to the battery fleet management server; a battery fleet management server programmed with an allocation algorithm configured to determine, based on real-time supply and demand data, where to dispatch the plurality of mobile battery units to maximize revenue for the solar field, the allocation algorithm further taking into account factors including haul distance, local diesel prices, and permissible noise or emissions limits at the remote operations; and
a transaction platform executing on or in communication with the battery fleet management server, the transaction platform being structured to compute a billing rate for each kilowatt-hour delivered by the mobile battery units to the remote operations, to finalize an energy delivery contract between the solar field owners and remote operation operators, and to reconcile payments in accordance with a location-based pricing model.

17. The system of claim 16, wherein
the battery fleet management server is further configured to dynamically update the allocation algorithm in near real time based on at least one of new weather reports affecting solar output, traffic congestion data affecting travel times for the mobile battery units, or emergent load demands from additional remote industrial sites.

18. The system of claim 16, wherein
each mobile battery unit further comprises an autonomous navigation subsystem configured to enable partially or fully unmanned transport of the mobile battery unit between the solar field and the remote operations.

19. The system of claim 16, further comprising
a transaction interface accessible by remote operation managers, the transaction interface being configured to receive binding requests for specific quantities of energy and delivery windows, and wherein the battery fleet management server is further configured to evaluate multiple incoming requests and assign mobile battery units to the most profitable energy delivery opportunity.

20. The system of claim 16, further comprising
a maintenance reporting module in communication with the battery fleet management server, the maintenance reporting module being configured to evaluate sensor data from the plurality of mobile battery units, including ambient temperature, mechanical vibrations, and battery state-of-health parameters, and to schedule predictive maintenance or issue service alerts based on deviations from normal operating thresholds.
